(19) United States
(12) Patent Application Publication
(10) Pub. No.: US 2026/0336806 A1
(43) Pub. Date: Oct. 29, 2026

(54) OVERHEAD BIN MANAGEMENT SYSTEM FOR PASSENGER AIRCRAFT

(71) Applicant: Enterprise Electronics LLC, Madison Heights, MI (US)

(72) Inventors: Thomas Gannon Wheeler, Birmingham, MI (US); Jeffrey Carl Vogel, Troy, MI (US)

(73) Assignee: Enterprise Electronics LLC, Madison Heights, MI (US)

(21) Appl. No.: 19/655,029

(22) Filed: Apr. 22, 2026

Related U.S. Application Data
(60) Provisional application No. 63/795,947, filed on Apr. 28, 2025.

(51) Int. Cl. B64D 11/00

(52) U.S. Cl. CPC B64D 11/003; B64D 11/0015

(57) ABSTRACT

A system that manages use of overhead bins in an aircraft or other vehicle includes a user interface and indicator pad. The indicator pad connects to an outer surface of a bin and indicates its full-and-closed (FAC) state. The system may include a security key and lock set, with key rotation in the lock set establishing the FAC state. The user interface may generate a signal indicative of the FAC state. A processor may turn on a lighting device in response to the signal. Switches of a switching control circuit may connect a battery to the lighting device. The processor may control a switching frequency of the switches such that the lighting device is not continuously illuminated. A display screen of the user interface may display a map of the overhead bins and a corresponding FAC state of each bin.

### CROSS-REFERENCE TO RELATED APPLICATIONS

The present application claims the benefit of priority to United States Provisional Application No. 63/795,947 filed on Apr. 28, 2025, which is hereby incorporated by reference in its entirety for all purposes.

### INTRODUCTION

The present disclosure relates to flight crew-operated systems and methods for managing use of overhead bins aboard a passenger aircraft, and for communicating an occupancy status thereof.

Airplane passengers and flight crew members are permitted to store smaller pieces of luggage and other carry-on items within a series of overhead bins. In a typical commercial airplane having multiple rows of passenger seats, the overhead bins are securely mounted to the airplane’s fuselage structure at an accessible position above the passenger seats. Each overhead bin is equipped with a bin door. For passenger protection, the bin doors are closed and securely latched prior to takeoff, with in-flight access to the bins permitted at the discretion of the flight crew members.

During a cross-check process, a flight attendant is tasked with visually inspecting each overhead bin during passenger boarding and prior to takeoff. When a given overhead bin is full, the flight attendant closes and latches the bin door. Later, when the airplane is in level/non-turbulent flight, e.g., while cruising at altitude with “fasten seatbelts” signs turned off, passengers may be permitted to walk about the cabin and access previously closed bins to access their stowed items. Otherwise, overhead bins in a modern aircraft remain closed during all phases of flight.

### SUMMARY

Disclosed herein are automated computer-based systems and corresponding control strategies for identifying when an overhead bin of an airplane is in a “full and closed” (FAC) state, i.e., when the overhead bin is full and its corresponding bin door is securely closed. The present teachings also provide a solution for clearly identifying/displaying the FAC state on an external surface of the bin doors.

As appreciated by those skilled in the art, the ongoing management of carry-on luggage remains an impediment to an aircraft’s timely departure, and thus is potentially detrimental to critical on-time departure metrics. An aircraft passenger is generally required to use designated bin space for their assigned seat regardless of the actual aircraft passenger load. This often causes passengers to scramble in search of available overhead bin space when nearby bins are full, which in turn further delays boarding. Carry-on baggage handling delays likewise can cause the aircraft to miss a scheduled takeoff timeslot - a metric that is especially critical for international or transoceanic flights.

The disclosed system is intended to address aircrew challenges related to efficient management of overhead bin space usage while improving overall passenger satisfaction. The solutions described below also reduce instances of delayed flights due to, e.g., passengers re-opening closed overhead bins when searching for available bin space. The present approach assists flight crews and passengers by clearly indicating whether a given overhead bin is presently full (or empty), for instance by indicating the above-noted FAC state via a color-coded light, a logo, or another representation of the FAC state. Among other possible benefits, adoption by aircraft manufacturers or commercial airlines of the present teachings may improve on-time departure rates and ensure the timely completion of flight safety checks.

In accordance with one or more representative embodiments, a system for managing use of an overhead bin on a passenger airplane or other vehicle equipped with such overhead bins includes a user interface and an indicator circuit. The latter is referred to herein as an indicator pad for clarity to indicate its optional “self-stick” or adherable construction. The user interface is configured to set a FAC state of the corresponding overhead bin. The indicator pad, which is connected to an outer (i.e., passenger-facing) surface of a bin door of the overhead bin, is configured to display the FAC state of the overhead bin to which the indicator pad is connected.

The user interface in a possible physical/mechanical construction includes a security key. The FAC state in this optional embodiment is set by rotation of the security key in a mating lock set located on the indicator pad. The FAC state may be indicated using a predetermined color, text, and/or logo indicative of the FAC state, with “and/or” as used herein meaning one, several, or all of the listed items.

Alternatively, the user interface may be used to generate an electronic or electrical signal visually indicative of the FAC state, for instance when the user interface is configured as a tablet or laptop computer. The indicator pad in such an embodiment may include a lighting device, a receiver circuit in communication with the user interface, and a processor (e.g., microprocessor or central processing unit) connected to the lighting device. The processor may be configured to turn on the lighting device in response to the signal from the user interface to thereby illuminate the lighting device in a predetermined color, for instance red, to indicate that the closed bin is also full. While an overhead bin having an open bin door may not require indication of its FAC state - the contents already being visible to the naked eye through the open bin door - in some implementations the lighting device may be illuminated in a suitable color such as green to indicate that the overhead bin has remaining capacity.

The receiver circuit may include a radio frequency (RF) receiver or an optical receiver in two non-limiting embodiments. Embodiments of the disclosed system may also include a near-field communication (NFC) circuit for communicating between the user interface and the indicator pad using a suitable NFC protocol, for instance to allow a flight attendant to easily change a setting of the indicator pad using a connected smartphone or other portable electronic device while moving through the passenger cabin during a cross-check process.

The indicator pad in one or more embodiments may include a battery and a switching control circuit that selectively connects the battery to the above-noted lighting device. The processor in such a construction is configured, in response to the signal, to close one or more switches of the switching control circuit to thereby connect the battery to the lighting device. The processor may be programmed to control a duty cycle of the various switches of the switching control circuit such that the lighting device is not continuously illuminated. Such an implementation may be used to increase battery life without compromising information content of the displayed FAC state.

In one or more implementations, a companion indicator lamp may be positioned externally to the bin door, for instance on a stationary portion of the overhead bin or on/near a ceiling of the passenger cabin. The optional companion indicator lamp may illuminate, in conjunction with illumination of the lighting device, to provide additional indication of the FAC state, for instance when the open bin door otherwise obscures visibility of the lighting device.

Continuing with this summary of the disclosure, the indicator pad in one or more additional embodiments may include an adhesive surface configured to securely stick/adhere the indicator pad to the outer surface of the bin door of the overhead bin without the aid of screws, rivets, or other surface-penetrating fasteners.

In a possible configuration, the user interface may also include a display screen configured to display a map or graphic of the overhead bins and a corresponding FAC state of each overhead bin.

A method of managing use of an overhead bin in a passenger aircraft is also disclosed herein. In general, the method includes setting a FAC state of the overhead bin via a user interface. In response to an action of the user interface, the method includes indicating the FAC state of the overhead bin via an indicator pad connected to an outer surface of a bin door of the overhead bin as described above.

Also disclosed herein is a system for managing use of an overhead bin in a passenger aircraft in which the system includes a tablet computer configured to set a FAC state of an overhead bin via a signal, and an indicator pad that is adherable to an outer surface of a bin door of the overhead bin without the aid of fasteners. The indicator pad is operable, in response to the signal from the tablet computer, for indicating the FAC state of the overhead bin via a lighting device of the indicator pad when the overhead bin is closed. The indicator pad in this particular embodiment also includes a processor, a battery, the lighting device, and a switching control circuit. The switching control circuit for its part has one or more switches, e.g., solid-state switches such as metal-oxide semiconductor field effect transistors (MOSFETs), that selectively connect the battery to the lighting device. The processor in this alternative embodiment is configured, in response to the signal, to close the one or more switches and thereby illuminate the lighting device.

The above-described features and advantages and other possible features and advantages of the present disclosure will be apparent from the following detailed description of the best modes for carrying out the disclosure when taken in connection with the accompanying drawings.

### BRIEF DESCRIPTION OF THE DRAWINGS

FIG. 1 is an illustration of overhead bins of a representative passenger aircraft, with the overhead bins equipped with an aircrew-operated system for managing the overhead bins in accordance with the disclosure.

FIG. 1A is a perspective view illustration of a representative indicator pad usable as part of the present system for managing overhead bins aboard a passenger aircraft.

FIG. 2 illustrates open/full and closed bin doors for overhead bins of the exemplary aircraft shown in FIG. 1, with an adhesive-backed indicator pad adhered to the closed bin door.

FIG. 3 is a schematic circuit diagram illustrating processor-based control of a switching control circuit usable with the indicator pad of FIG. 2 in accordance with one or more embodiments.

FIGS. 4A and 4B are plan view illustrations of a lockset and a security key, respectively, which together are usable as a user interface in accordance with a possible implementation.

FIGS. 5A and 5B illustrate respective open/available and full-and-closed (FAC) states of the overhead bins of FIGS. 1 and 2.

FIG. 6 is a representative map/graphic for display via the user interface.

FIG. 7 is a flow chart describing an exemplary method for operating the present bin management system.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Dimensions disclosed in the drawings or elsewhere herein are for the purpose of illustration.

### DETAILED DESCRIPTION

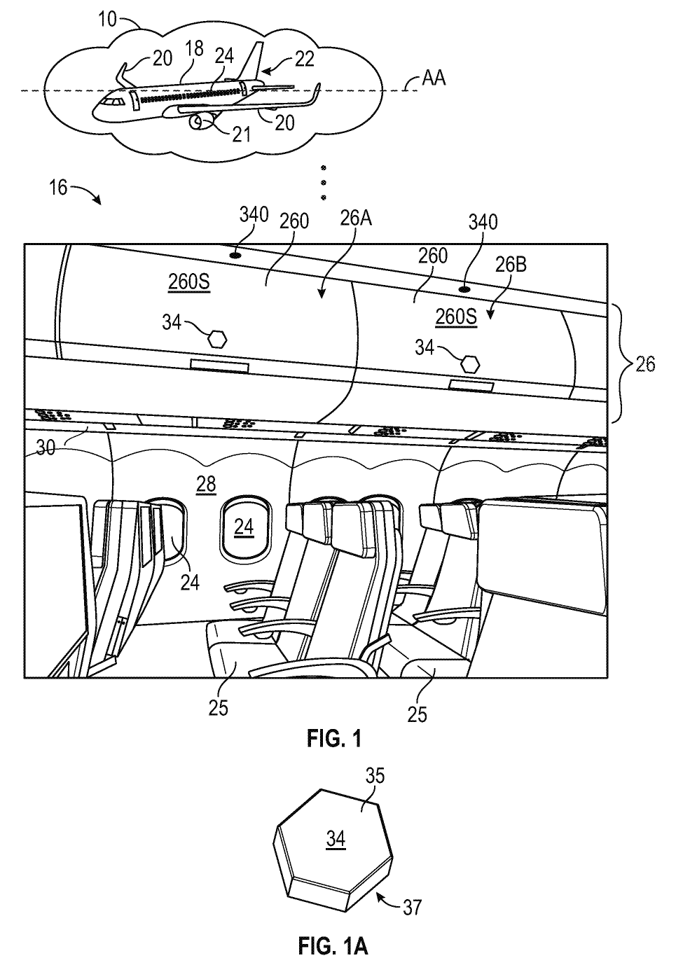

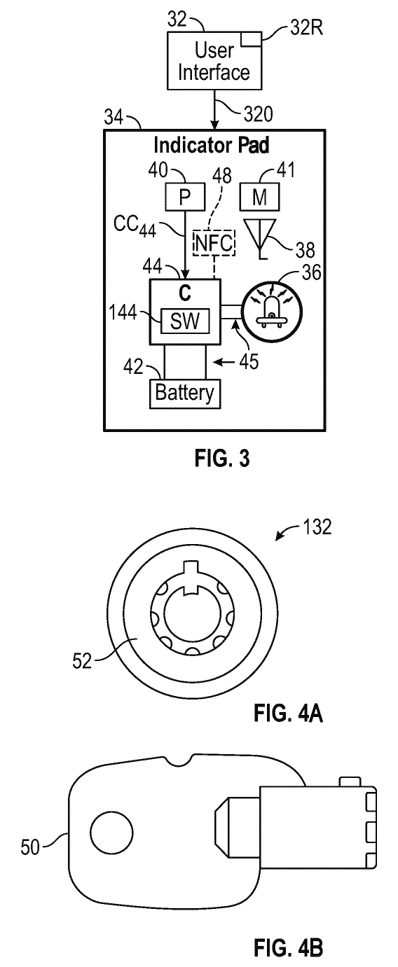

Referring to the drawings, wherein like reference numbers refer to like components, an aircraft 10 in the form of a commercial passenger airplane is illustrated in FIG. 1. The aircraft 10 is equipped with a system 12 (also see FIG. 3) for managing use of overhead bins 26 within a passenger cabin 16 of the aircraft 10. The aircraft 10 in a possible fixed-wing construction includes a fuselage 18 having a longitudinal axis AA, wings 20 connected to the fuselage 18, engines 21 or other propulsors connected to the wings 20, and an empennage assembly 22 at the rear of the aircraft 10. The fuselage 18 includes a series of passenger windows 24. Each passenger window 24 is located adjacent to one or more rows of passenger seats 25 to admit light into the passenger cabin 16 and afford passengers with an external view.

Within the passenger cabin 16, the overhead bins 26 with corresponding curvilinear or planar bin doors 260 are securely mounted to the fuselage 18 at an accessible position directly above the passenger seats 25. For simplicity, representative overhead bins 26A and 26B are shown in the partial perspective view of the passenger cabin 16 of FIG. 1. The overhead bins 26 run parallel to an aisle 17 (FIG. 6) adjacent to the passenger seats 25, with a pair of such aisles being present in larger/transoceanic versions of the aircraft 10, as appreciated in the art.

The passenger windows 24 of FIG. 1 are formed in a sidewall 28 of the fuselage 18. As needed, passengers seated in the passenger seats 25 may access a passenger service unit (PSU) 30 located directly above each row of seats 25 and integrated into the underside of the overhead bins 26. The PSU 30 contains various interfaces, typically including reading lights, air conditioning vents, flight attendant call buttons, oxygen mask panels, and illuminable signage such as “fasten seatbelts”. The system 12 described herein, which does not require rewiring of the fuselage 18 or reconfiguration thereof, operates without interfering with passenger access to or functions of the PSU 30, while at the same time maintaining all intended functionality of/access to the overhead bins 26.

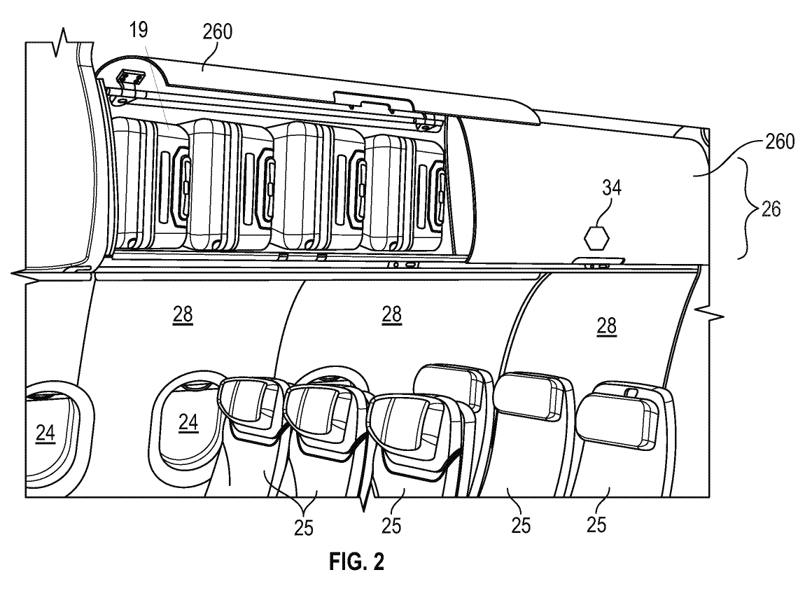

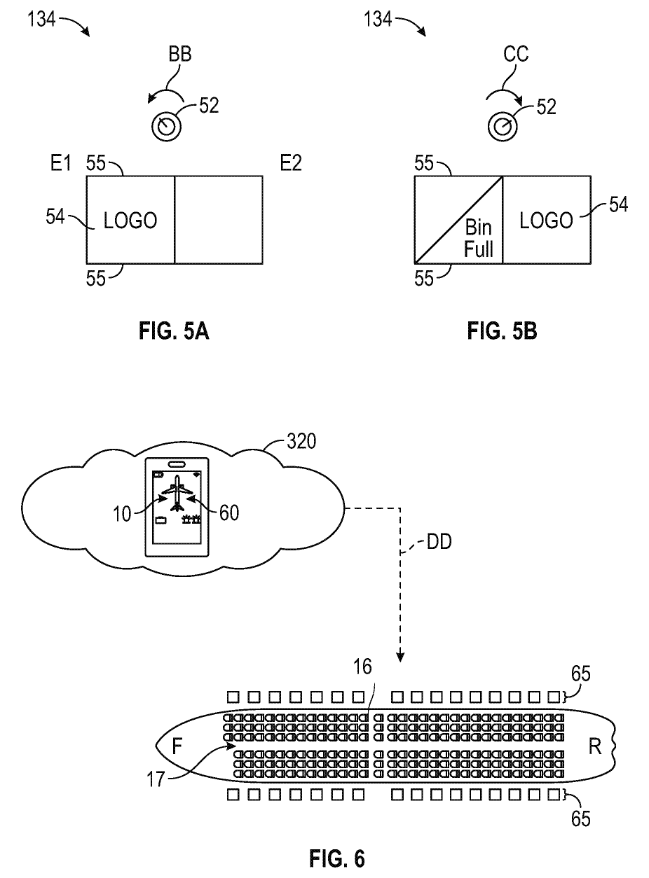

Referring briefly to FIG. 2 in conjunction with FIG. 1, the system 12 for managing use of the overhead bins 26 includes a user interface 32 (FIG. 3) and an indicator pad 34. In general, the user interface 32 is configured to set a full-and-closed (FAC) state of each of the overhead bins 26, while the indicator pad 34 is connectable to an outer surface of the overhead bins 26 and configured, in response to an input action from the user interface 32, to visually indicate the FAC state of the overhead bins 26 on the outer surface when the overhead bins 26 are in a closed state. The user interface 32 is configured to set the FAC state of each respective one of the overhead bins 26. This occurs in response to an input action of the user interface 32, e.g., a manual action (FIGS. 4, 5A, and 5B, ) or via an electronic action (FIGS. 3 and 6).

The displayed FAC state as used herein describes a “full” state of an overhead bin 26 in terms of its remaining capacity. A full overhead bin 26 as envisioned herein is one that, from the perspective and professional discretion of a flight attendant, has insufficient remaining capacity for additional carry-on items. The “closed” aspect of the FAC state refers to a closed/shut position of the bin door 260. When the overhead bin 26 has remaining capacity or the door is open, the FAC state in turn corresponds to “not full” or “open”, whatever the case may be.

As shown in FIGS. 1 and 2, the indicator pads 34 are connectable to an outer surface 260S of a respective bin door 260. As illustrated in FIG. 1A, the indicator pad 34 in a possible construction includes a passenger/cabin-facing front surface 35 and a rear surface 37. The rear surface 37 may be configured to securely adhere to the outer surface 260S of the bin door 260 of a given overhead bin 26. Surface adhesion may occur without the aid of surface-penetrating fasteners such as screws or rivets, thereby eliminating the need to puncture or mar the bin door 260. An optional companion lamp 340 may be attached externally to the bin doors 260, for instance to a stationary portion of the overhead bins 26 or a ceiling of the passenger cabin.

Representative implementations of the rear surface 37 (or materials applied thereto) include, without limitation, a non-marring foam layer having adhesive material applied to both sides, high-bond acrylic foam tape, adhesive discs, and the like. Once properly attached to the bin door 260, the indicator pad 34 is thereafter operable for visually indicating the current FAC state of the overhead bin 26 to which the indicator pad 34 is attached, and in particular when the bin door 260 of the overhead bin 26 is closed and its contents are no longer visible to the naked eye.

During passenger boarding of the aircraft 10 of FIG. 1, as well as during stable/cruise portions of flight, one or more of the overhead bins 26 of FIGS. 1 and 2 may be open to allow passenger or flight attendant access. As noted above, the overhead bins 26 in the passenger cabin 16 may be used to secure carryon items such as briefcases, backpacks, rolling suitcases, purses, etc. In the representative scenario of FIG. 2, the internal volume of the overhead bin 26A at left (also see FIG. 1) is filled with carry-on items 19, but the corresponding bin door 260 remains open. In contrast, the bin door 260 of the overhead bin 26B to the right of overhead bin 26A is closed.

Once activated by a flight attendant in accordance with the present disclosure, the indicator pad 34 of the overhead bin 26B will display the FAC state of the overhead bin 26B. In other words, a passenger seeking additional bin space in the passenger cabin 16 need not open the bin door 260 of overhead bin 26B to ascertain whether the overhead bin 26B is already full. Instead, the passenger simply views the indicator pad 34 to see that the overhead bin 26B has been filled to its permitted capacity. In some embodiments, the indicator pad 34 may present other information indicative of available space in an overhead bin 26 having a closed bin door 260, and therefore the present teachings are not limited to indication solely of a “full” status.

Referring now to FIG. 3, the user interface 32 is configured to generate an electronic or electrical signal 320 indicative of the FAC state of the overhead bin 26. The term "signal" as used herein refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The indicator pad 34, the shape of which may vary in different applications, e.g., square, circular, rectangular, polygonal as in FIGS. 1, 1A, and 2, etc., may include a lighting device 36, a receiver circuit 38 in communication with a receiver circuit 32R of the user interface 32, and a processor (P) 40 connected to the lighting device 36. In a possible configuration, the lighting device 36 may be embodied as a color diode array, for instance an array of red, green, blue (RGB) light-emitting diodes (LEDs) for efficient, long-term operation. The emitted color of such an LED embodiment may be selectable by the user interface 32 in one or more implementations.

In some implementations, the indicator pad 34 and the user interface 32 may communicate via near-field communication (NFC) using an NFC chip 48 to enable short-range wireless communication via electromagnetic induction, as appreciated in the art. For example, the NFC chip 48 may control communication between the receiver circuits 32R and 38 (or a separate antenna loop on the NFC chip 48) to exchange data, typically within 5 centimeters (cm) or less. The NFC chip 48 in such a construction may use a communication protocol and data processing logic to control the exchange of information between the user interface 32 and the indicator pad 34. Such a solution may operate bi-directionally or in a peer-to-peer mode in some implementations.

In a possible usage case, a flight attendant during a cross-check process may wave a smartphone near the indicator pad 34 to cause the lighting device 36 to change colors, e.g., red to green, or to turn off. For instance, the flight attendant prior to or upon boarding the aircraft, and in any case before passenger boarding, may log into an access-restricted application (“app”) using a secure password, two-factor authentication, secure hardware key (e.g., a Yubikey^{®}), facial recognition, biometric identification, or other secure approach. The flight attendant’s smartphone, acting in this case as the user interface 32, could then be used as the user interface 32 for performing designated functions. Use of such an app would also help ensure that passengers remain unable to control the illumination state on the indicator pad.

The receiver circuit 38 of FIG. 3 may also be variously embodied as an RF receiver or an optical receiver circuit. As appreciated, RF receivers are operable for receiving electromagnetic energy in a specific part of the RF spectrum, or about 3 kilohertz (kHz) to about 300 gigahertz (GHz). The receiver circuit 38 in such an embodiment may include an antenna, filters, etc. In contrast, an optical receiver works with electromagnetic waves in or near the visible light spectrum. Instead of an antenna, an optical receiver may employ one or more photodiodes to convert received photons into electrical signals for signal processing by the processor 40.

The processor 40 shown schematically in FIG. 3 is configured as a controller operable for turning on the lighting device 36 in response to the signal 320 from the user interface 32. Turning on the lighting device 36 results in illumination of the lighting device 36 in a predetermined color. For example, the predetermined color may be red in a representative embodiment to shown the FAC state as noted above. In other embodiments, the color may vary based on whether or not the overhead bin 26 is full, e.g., the lighting device 36 may be illuminated in green, white, amber, or another suitable color to indicate that bin space is available.

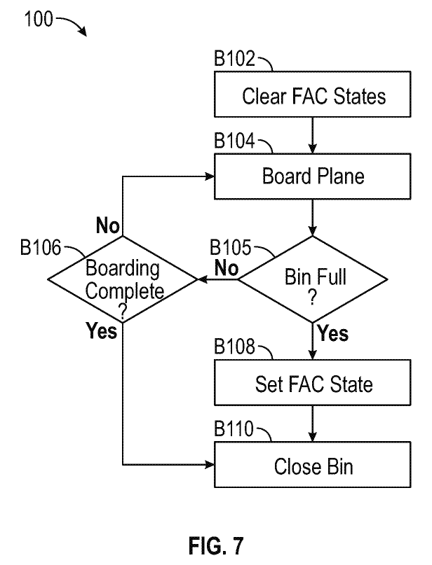

The processor 40 used for the various purposes described herein is shown schematically for illustrative simplicity, but may include Application Specific Integrated Circuit(s) (ASIC), a Field-Programmable Gate Array (FPGA), a central processing unit, etc. As needed, the processor 40 may be in communication with a non-transitory computer storage medium or memory (M) 41, e.g., to access instructions or software code for controlling operation of the lighting device 36. Ultimately, the processor 40 outputs control output signals (arrow CC₄₄) to a switching control circuit (C) 44 in the course of performing a method 100, an example of which is described below with reference to FIG. 7.

The system 12 in accordance with a possible implementation includes a battery 42 or other direct current (DC) power supply. The battery 42 is connected to the switching control circuit 44 via low-voltage wires (+, -) 45. The battery 42 may be a circular/disc-shaped battery such as a button cell or coin battery having a voltage rating of less than about 5 volts, e.g., of an alkaline, lithium, or silver oxide conduction. The switching control circuit 44 in turn may include one or more switches (SW) 144, for instance solid-state power switches such as metal-oxide semiconductor field effect transistors (MOSFETs). The switches 144 selectively connect the battery 42 to the lighting device 36 when activated by a suitable gate voltage. The processor 40 is configured in such an embodiment to close the switches 144 in response to the signal 320 to illuminate the lighting device 36.

In a possible implementation, the processor 40 of FIG. 3 is configured to control a duty cycle of the one or more switches 144, such that the lighting device 36 is not continuously illuminated, or is illuminated with reduced power. Such an approach may help to minimize drain on the battery 42 and extend its operating life, thereby reducing the replacement frequency of the indicator pad 34 and/or the battery 42 therein. Using such an approach, the processor 40 may command the switches 144 to close for a programmed duration before opening again, thereafter repeating the open/close switching control sequence for a predetermined time. Afterward, the battery 42 may be disconnected by operation of the switching control circuit 44, e.g., before takeoff and landing, and possibly during other phases or stages of the flight as required by the pilot, flight attendants, and applicable regulations.

Referring to FIGS. 4A and 4B, alternative mechanical implementations may be envisioned within the scope of the disclosure that would similarly alert passengers to the present FAC state of the various overhead bins 26. In a possible configuration, a user interface 132 includes a security key 50 (FIG. 4B) and an indicator pad 134 (also see FIGS. 5A and 5B) includes a lock set 52 (FIG. 4A). The lock set 52 in this particular embodiment is configured to receive the security key 50 therein when a flight attendant inserts the security key 50 into the lock set 52. The security key 50 and accompanying lock set 52 may be provided with a sufficiently unique mating configuration, for instance an airline-specific configuration, so as to prevent tampering with the indicator pads 134 of FIGS. 5A and 5B. The security key 50 may remain in possession of flight attendants aboard the aircraft 10 of FIG. 1 such that control of the FAC state remains with flight attendants at all times.

Referring to FIGS. 5A and 5B, a rotation of the security key 50 in the lock set 52 in a first direction (arrow BB of FIG. 5A) is configured to indicate that the overhead bin 26 has remaining space therein. For instance, a translatable panel 54, possibly embossed or printed with a logo of a particular airline or other operator/owner of the aircraft 10 of FIG. 1, is positioned at one end E1 of the indicator pad 134. The translatable panel 54 may be engaged with linear rails or slots 55 on a perimeter edge of the indicator pads 134 in a possible implementation. An opposing E2 may be blank, or opposing end E2 may be color-coded in, e.g., green or another suitable color, and/or emblazoned with text, a logo, etc., indicative of the overhead bin 26 having available space.

As illustrated in FIG. 5B, rotation of the security key 50 in the lock set 52 in a second direction (arrow CC) is configured to indicate that the overhead bin 26 is now full. In keeping with the above example, the translatable panel 54 formerly positioned at end E1 of the indicator pad 134 in FIG. 5A may translate in response to rotational force imparted to the lock set 52 by the security key 50. Translation of the translatable panel 54 to end E2 occurs via the rails or slots 55, thereby revealing a FAC panel 57 such as a red panel, and/or text (“BIN FULL”), a logo, etc., with the revealed FAC panel 57 being indicative of the overhead bin 26 being full. Other manual/mechanical implementations may be envisioned within the scope of the disclosure, with the user interface 132 or its variants ideally remaining at all times in the possession of flight attendants to maintain centralized control over the system 12.

Referring to FIG. 6, the user interface 32 described above may be configured as a user interface 32A in the form of a portable electronic device, for instance a tablet computer as shown, a touch-sensitive display panel situated near passenger doors of the aircraft 10 (FIG. 1), a laptop computer, etc. The user interface 32A in such an implementation includes a display screen 60. The user interface 32A may present an image or drawing of the aircraft 10. A flight attendant using the user interface 32A may select a map 160 or other graphic of the passenger cabin 16 of FIG. 1 via a “multi-touch” input to the display screen 60. The map 160 is thereafter presented on the display screen 60 as indicated by arrow DD.

The map 160 of FIG. 6 may include a plan/top-down view of the passenger cabin 16 and its various rows of seats 25. Adjacent to the seats 25, the map 160 may display a visual indicator 65, e.g., a red light, indicative of the FAC state of the corresponding overhead bins 26 (FIGS. 1 and 2) in the indicated area of the passenger cabin 16. For instance, while positioned near the front (F) of the aircraft 10, a flight attendant may view the map 160 on a tablet computer to determine approximate rows where available space remains in the overhead bins 26. Using the above red light example to indicate the FAC state, for instance, the flight attendant may quickly note the presence of red lights indicative of full-and-closed overhead bins 26 toward the back of the passenger cabin 16. Other flight attendants in that area of the passenger cabin 16 may previously set the FAC state using any of the above-described approaches, with overhead bins 26 lacking a FAC state having available space. Available overhead bins 26 may be indicated simply by the absence of a red light or other indicia of the FAC state, or using a suitable color such as green to indicate available bin space.

Thus, a flight attendant stationed near the front of the aircraft 10 may, with an elevated level of confidence and without departing from their present position, direct boarding passengers to the available bin space available toward the rear (R) of the aircraft 10. As the overhead bins 26 fill up during boarding, their corresponding status on the display screen 60 changes to the FAC state, e.g., red, in response to actions of the flight attendants. Likewise, flight attendants at the rear of the aircraft 10 are able to quickly ascertain bin availability near the front of the aircraft 10 without calling to other flight attendants on an intercom system or leaving their designated area of the passenger cabin 16.

In general, methods for operating the system 12 includes setting the FAC state of the overhead bin 26 via the user interface 32. In response to an action of the user interface 32, the indicator pad 34 displays or indicates the FAC state of the overhead bin 26. The user interface 32 in one or more embodiments may generate an electronic or electrical signal 320 indicative of the FAC state of the overhead bin 26. The lighting device of the indicator pad 34 may turn on in response to the signal 320 from the user interface 32 to illuminate the lighting device in a predetermined color.

As described above, turning on the lighting device may include closing one or more switches 144 of the switching control circuit 44, via the processor, to thereby connect the battery to the lighting device. Embodiments of the method 100 include adjusting a duty cycle of the one or more switches 144 via the processor such that the lighting device is not continuously illuminated, and/or displaying the map 160 of a plurality of the overhead bins 26 via the display screen 60 of the user interface 320A of FIG. 6. The method 100 may also include displaying a corresponding FAC state of each of the plurality of overhead bins 26 on the map 160.

Referring now to FIG. 7, the method 100 for managing use of the overhead bins 26 in the passenger aircraft 10 of FIG. 1 includes or is predicated on providing the above-described user interface 32 and indicator pads 34. The method 100 may be implemented aboard the passenger aircraft 10 once the indicator pads 34 are adhered to the various overhead bins 26.

Commencing with block B102 (“Clear FAC States”), the indicator pads 34 may be cleared of prior-set full-and-closed (FAC) state settings. Block B102 may include setting the various indicator pads 34, via the user device 32, to a default state indicative of the overhead bins 26 being empty. The default state may be set, for instance, when the aircraft 10 of FIG. 1 has landed and passengers have exited the aircraft 10. The method 100 proceeds to block B104 after the indicator pads 34 are in the default state.

Block B104 (“Board Plane”) includes commencing boarding of the aircraft 10 prior to a new flight. The method 100 proceeds to block B105 as passengers enter the passenger cabin 16 and move along an aisle to locate their seats 25.

At block B105 (“Bin Full?”), the method 100 includes determining whether a given one of the overhead bins 26 is full. A flight attendant or other authorized aircrew member may perform block B105 by visually inspecting the overhead bin 26 and determine, using the flight attendant’s professional judgment, whether additional carry-on items may be safely added. The method 100 proceeds to block B106 when the overhead bin 26 is not full, and to block B108 in the alternative when the overhead bin 26 is full.

Block B106 (“Boarding Complete?”) includes determining whether all passengers have board the aircraft 10 of FIG. 1. The method returns to block B104 when boarding remains ongoing. The method 100 proceeds in the alternative to block B110 when boarding is complete.

Block B108 (“Set FAC State”) includes setting the FAC state of the overhead bin 26 using the user interface 32 or 32A as described above. The method 100 proceeds to block B110 once the FAC state is properly displayed via the indicator pad 34, e.g., as a corresponding color such as red, and/or a corresponding logo, text, etc.

At block B110 (“Close Bin Door”), the method 100 includes closing the bin door 260 of the full overhead bin 26. A flight attendant takes this action when the overhead bin 26, in the discretion of the flight attendant or other crew member, is deemed to be full (from block B108) or boarding is otherwise complete (from block B106). The method 100 is finished once the bin door 260 has been closed.

As noted above, implementation of the present solutions does not require reconfiguration of existing aircraft fleets. Instead, aircraft manufacturers, airlines, or other owners/operators of the aircraft 10 of FIG. 1 may removably adhere the indicator pads 34 to the bin doors 260. No other preparation of the aircraft 10 is required. Additionally, unlike bin scales and other weight-based approaches that can provide false readings when the overhead bins 26 are overfilled or contain improperly placed items, or competing approaches employing easily damaged overhead cameras, the system 12 described above may be used with existing overhead bins 26 as an aftermarket option.

Indication of the present FAC state is controlled by flight crew members with the assistance of the user interface 32, the construction of which varies in different implementations. Passengers are therefore prevented from changing the FAC state on their own. Flight attendants and other crew members may use the present teachings to determine overhead bin availability, which in turn would allow flight attendants to direct passengers and gate-check luggage in a more efficient manner. These and other attendant benefits of the foregoing disclosure will be readily appreciated by those of ordinary skill in the art, now having the benefit of the foregoing disclosure.

Embodiments of the present disclosure are described herein. The disclosed embodiments are merely examples and other embodiments can take various and alternative forms. The drawings are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

We claim:

1. A system for managing use of an overhead bin in a passenger aircraft, the system comprising:
a user interface configured to set a full-and-closed (FAC) state of the overhead bin; and
an indicator pad that is connectable to an outer surface of the overhead bin, wherein the indicator pad is configured, in response to an input action of the user interface, to visually indicate the FAC state of the overhead bin on the outer surface when the overhead bin is in a closed state.

2. The system of claim 1, wherein the user interface is configured to generate a signal indicative of the FAC state of the overhead bin, and wherein the indicator pad includes:
a lighting device;
a receiver circuit in communication with the user interface; and
a processor connected to the lighting device and the receiver circuit, wherein the processor is configured to turn on the lighting device in response to receipt by the receiver circuit of the signal from the user interface.

3. The system of claim 2, wherein the user interface and the indicator pad are configured to exchange information via a near-field communication (NFC) protocol.

4. The system of claim 2, further comprising:
a battery; and
a switching control circuit having one or more switches that selectively connect the battery to the lighting device, wherein the processor is configured, in response to the signal, to close the one or more switches and thereby illuminate the lighting device.

5. The system of claim 4, wherein the battery is a coin battery having a voltage rating of less than about 5 volts.

6. The system of claim 2, wherein the processor is configured to adjust a duty cycle of the one or more switches such that the lighting device is not continuously illuminated.

7. The system of claim 2, wherein the receiver circuit includes a radio frequency (RF) receiver operable for receiving the signal.

8. The system of claim 2, wherein the receiver circuit includes an optical receiver operable for receiving the signal.

9. The system of claim 1, wherein the indicator pad includes an adhesive surface configured to adhere the indicator pad to the outer surface of the overhead bin without the aid of surface-penetrating fasteners.

10. The system of claim 1, wherein the user interface includes a tablet computer.

11. The system of claim 1, wherein the user interface includes a display screen that is configured to display:
a map of a plurality of the overhead bins; and
a corresponding FAC state of each of the plurality of overhead bins.

12. The system of claim 1, wherein the user interface includes a security key, the indicator pad includes a lock set configured to receive the security key therein, and a rotation of the security key in the lock set is configured to set the FAC state of the overhead bin.

13. The system of claim 1, wherein the FAC state is indicated as a predetermined logo.

14. A method of managing use of an overhead bin in a passenger aircraft, the method comprising:
setting a full-and-closed (FAC) state of the overhead bin via a user interface; and
in response to an input action of the user interface, indicating the FAC state of the overhead bin via an indicator pad that is connected to an outer surface of the overhead bin, including visually indicating when the overhead bin is in a closed state.

15. The method of claim 14, further comprising:
generating, via the user interface, a signal indicative of the FAC state of the overhead bin; and
turning on a lighting device of the indicator pad in response to the signal from the user interface to thereby illuminate the lighting device in a predetermined color.

16. The method of claim 15, wherein turning on the lighting devices includes energizing a color diode array of red, green, and blue (RGB) light-emitting diodes.

17. The method of claim 14, wherein turning on the lighting device of the indicator pad in response to the signal includes closing one or more switches of a switching control circuit, via the processor, to thereby connect a battery to the lighting device.

18. The method of claim 17, further comprising:
adjusting a duty cycle of the one or more switches via the processor such that the lighting device is not continuously illuminated.

19. The method of claim 14, further comprising:
displaying a map of a plurality of the overhead bins via a display screen of the user interface; and
displaying a corresponding FAC state of each of the plurality of overhead bins on the map.

20. A system for managing use of an overhead bin in a passenger aircraft, comprising:
a tablet computer configured to set a full-and-closed (FAC) state of the overhead bin via a signal; and
an indicator pad that is adherable to an outer surface of the overhead bin without the aid of surface-penetrating fasteners, and operable, in response to the signal from the tablet computer, for indicating the FAC state of the overhead bin via a lighting device of the indicator pad when the overhead bin is closed, the indicator pad comprising:
a processor;
a battery;
the lighting device; and
a switching control circuit having one or more solid-state switches that selectively connect the battery to the lighting device, wherein the processor is configured, in response to the signal, to close the one or more solid-state switches and thereby illuminate the lighting device.
